(19) United States
(12) Patent Application Publication
(10) Pub. No.: US 2010/0187457 A1
(43) Pub. Date: Jul. 29, 2010

(54) SOLENOID VALVE

(76) Inventor: Dietmar Kratzer, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/664,174

(22) PCT Filed: Apr. 11, 2008
(86) PCT No.: PCT/EP2008/054396

§ 371 Date: Dec. 11, 2009

(30) Foreign Application Priority Data
Jun. 11, 2007 (DE) 10 2007 026 890.6

(51) Int. Cl. F16K 31/02

(52) U.S. Cl. 251/129.15

(57) ABSTRACT

The invention relates to a solenoid valve with a magnet assembly and a valve cartridge. The valve cartridge includes a capsule and an armature which is movably disposed within the capsule and which has a first closing element which interacts with a main valve seat to form a seal. A magnetic force, generated by the magnet assembly, moves the armature with the first closing element, as a result of which the first closing element with a first sealing region dips into the main valve seat to form a seal. According to the invention, the capsule is constructed with an inner curvature in order to reduce the overall height of the valve cartridge. An upper end of the armature is fitted to the shape of the inner curvature of the capsule by means of a depression.

### PRIOR ART

The invention relates to a solenoid valve as generically defined by the preamble to independent claim 1.

A conventional solenoid valve, in particular for a fluid block, which is used for instance in an anti-lock brake system (ABS) or a traction control system (TC system) or an electronic stability program system (ESP system), is shown in FIG. 1. As seen in FIG. 1, a conventional solenoid valve 11, which is embodied for instance as a regulating valve that is open when without current, includes a magnet assembly 2 for generating a magnetic flux, which assembly includes a housing jacket 4 with an intake 4.1, a winding holder 5, a coil winding 5.1, and a covering disk 6; and a valve cartridge 10, which includes a capsule 1, a valve insert 12, an armature 13 with a first closing element 14 embodied as a tappet, and a restoring spring 15. The magnet assembly 2 generates a magnetic force which moves the longitudinally movable armature 13, with the first closing element 14 embodied as a tappet, toward the valve insert 12 counter to the force of the restoring spring 15. The coil winding 5.1 wound onto the winding holder 5 forms an electrical coil, which is triggerable via electrical terminals 7. The valve insert 12 conducts the magnetic flux, introduced by the magnet assembly 2 via the covering disk 6, axially in the direction of the armature 13 via an air gap 8. The magnetic transition from the armature 13 to the magnet assembly 2 takes place in the upper region of the capsule 1, via the intake 4.1. As a result of current being supplied to the coil winding 5.1 via the electrical terminals 7 and the magnetic flux generated as a result, the armature 13 is moved toward the valve insert 12, counter to the force of the restoring spring 15. Moreover, the valve insert 12 receives the so-called valve body 16, which includes a primary valve seat 17 into which the first closing element 14, embodied as a tappet, plunges in sealing fashion via a sealing region 14.1 embodied as a sealing dome, in order to achieve the sealing function of the solenoid valve 11. Moreover, the conventional solenoid valve 11 includes a check valve 20, which performs a directionally oriented flow function and includes as its essential parts a movable second closing element 22, a sealing seat 24 disposed in a check valve holder 21, and a stroke limiter or contact that limits the maximum stroke of the movable second closing element 22. The stroke limitation is effected by means of a flat filter 23, which like an annular filter 25 is also supported by the check valve holder 21.

As can also be seen from FIG. 1, for reasons of strength, the end of the capsule 1 of the solenoid valve 11 is embodied in convex form. The magnet armature 13 follows this shape and touches the capsule 1 in a defined region 3 above the magnetic transition from the intake 4.1 of the housing jacket 4, so that the capsule 1, in the defined contact region 3, forms an upper stop for the magnet armature 13. The result is a length h, which is a measure for the height of the part of the valve cartridge 10 that is disposed above a fluid block. For filling the curved capsule form and to avoid an overly large volume of fluid or air in this region, the magnet armature 13 is embodied in curved fashion as well. The curved region of the magnet armature 13 contributes to the length of the solenoid valve cartridge 10.

### DISCLOSURE OF THE INVENTION

The solenoid valve according to the invention having the characteristics of independent claim 1 has the advantage over the prior art that for reducing the structural height, the capsule of the valve cartridge is embodied with a concave curvature, and an upper end of the armature is adapted by means of an indentation to the shape of the concave curvature of the capsule. As a result of the concave curvature of the capsule and the indentation of the armature, the curved, magnetically unused region of the armature is advantageously shortened, so that the valve cartridge can be shortened as well, yet the strength of that end of the capsule is preserved. As a result, advantageously, more space can be created for conductor tracks of a control unit that are disposed directly above the valve cartridge, and the height of the overall fluid block can be reduced. As a result, the armature of the solenoid valve of the invention has only a very small region that is magnetically unused, or none at all. Moreover, the structural volume of the fluid block, which is important for automobile development, can be reduced. Under favorable conditions, the height of the magnet group can be reduced as well by means of a skillful adaptation of geometry, if the magnet field lines follow the new armature shape.

By means of the provisions and refinements recited in the dependent claims, advantageous improvements to the solenoid valve defined by independent claim 1 are possible.

It is especially advantageous that a contact region between the armature and the capsule occurs in the armature indentation that, in the outset position of the armature, contacts the concave curvature of the capsule. The contact region between the indentation of the armature and the concave curvature of the capsule acts for instance as a stroke stop of the armature. The maximum stroke of the armature can then be adjusted for instance via the depth of the concave curvature.

Alternatively, the concave curvature of the capsule and the indentation of the armature can be adapted to one another such that the contact region occurs between the armature and the capsule at the edge of the indentation of the armature and, in the outset position of the armature, contacts the edge of the concave curvature of the capsule. The indentation of the armature is for instance embodied as large enough that no contact with the concave curvature of the capsule ensues there. As a result, the known course of the magnet field lines and thus the magnetic behavior are preserved, at the cost of a lesser reduction in the structural height.

In a feature of the solenoid valve of the invention, the armature is embodied as a cold-formed part, and the sealing region of the first closing element is reworked by means of a restamping process. An underlay created upon the cold-forming of the armature defines the indentation of the armature in shape and depth.

Advantageous embodiments of the invention, described below, as well as the conventional exemplary embodiment described above for the sake of better comprehension, are shown in the drawings. In the drawings, identical reference numerals identify components and elements that perform the same or analogous functions.

### BRIEF DESCRIPTION OF THE DRAWINGS

FIG. 1 shows a schematic sectional view of a conventional solenoid valve.

FIG. 2 shows a schematic sectional view of a first exemplary embodiment of a solenoid valve according to the invention.

FIG. 3 shows a schematic sectional view of a second exemplary embodiment of a solenoid valve according to the invention.

### EMBODIMENTS OF THE INVENTION

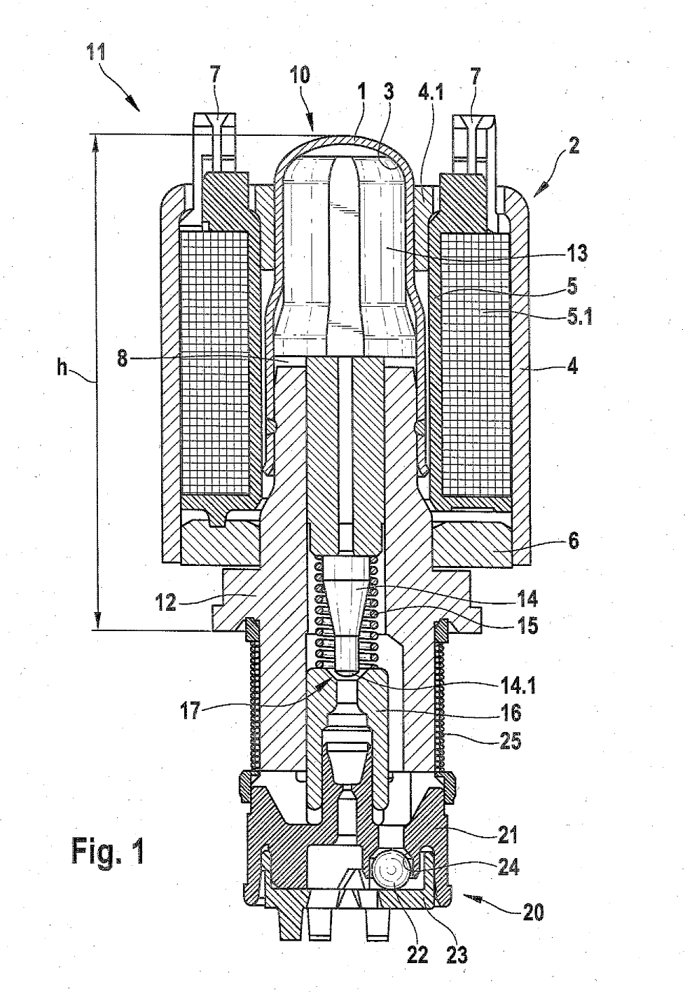

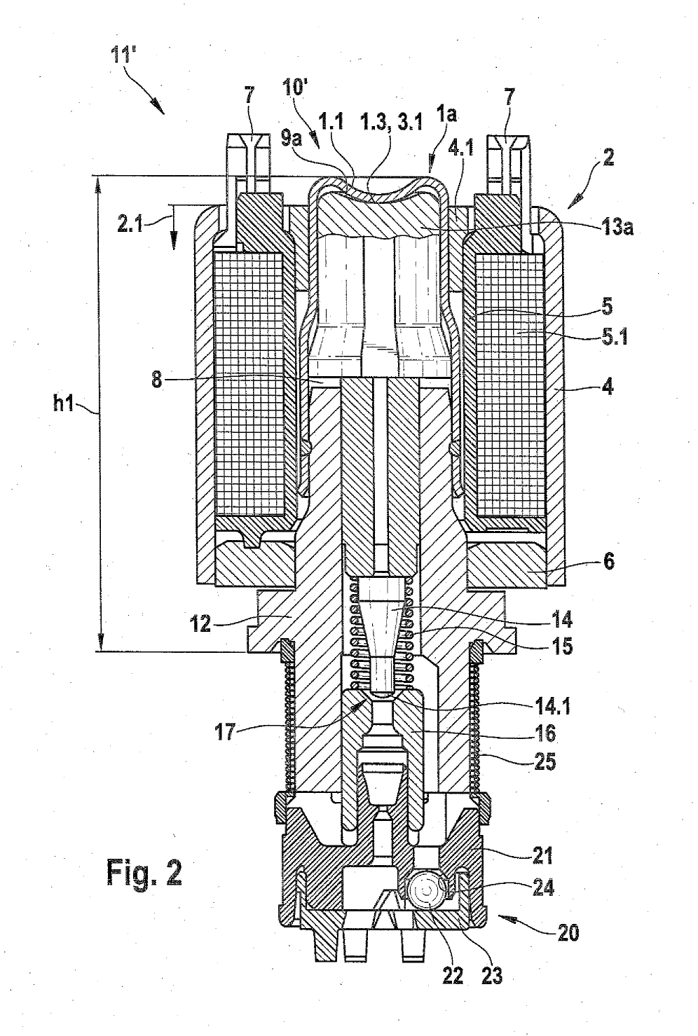

As can be seen from FIG. 2, the first exemplary embodiment of the solenoid valve 11′ of the invention, analogously to the conventional solenoid valve 11 of FIG. 1, includes a magnet assembly 2 for generating a magnetic flux, which assembly includes a housing jacket 4 with an intake 4.1, a winding holder 5, a coil winding 5.1, and a covering disk 6; and a valve cartridge 10′, which includes a capsule 1a, a valve insert 12, an armature 13a with a first closing element 14 embodied as a tappet, and a restoring spring 15. The magnet assembly 2 generates a magnetic force which moves the longitudinally movable armature 13a, with the first closing element 14 embodied as a tappet, toward the valve insert 12 counter to the force of the restoring spring 15. The coil winding 5.1 wound onto the winding holder 5 forms an electrical coil, which is triggerable via electrical terminals 7. The valve insert 12 conducts the magnetic flux, introduced by the magnet assembly 2 via the covering disk 6, axially in the direction of the armature 13a via an air gap 8. The magnetic transition from the armature 13a to the magnet assembly 2 takes place in the upper region of the capsule 1a, via the intake 4.1. As a result of current being supplied to the coil winding 5.1 via the electrical terminals 7 and the magnetic flux generated as a result, the armature 13a is moved toward the valve insert 12, counter to the force of the restoring spring 15. Moreover, the valve insert 12 receives the valve body 16, which includes a primary valve seat 17 into which the first closing element 14, embodied as a tappet, plunges in sealing fashion via a sealing region 14.1 embodied as a sealing dome, in order to achieve the sealing function of the solenoid valve 11′. Moreover, the solenoid valve 11′ of the invention includes a check valve 20.

In a distinction from the conventional solenoid valve 11 of FIG. 1, the capsule 1a of the solenoid valve 11′ of the invention, for reducing the structural height of the valve cartridge 10′, is embodied as shown in FIG. 2 with a concave curvature 1.1, and an upper end of the armature 13a is adapted by means of an indentation 9a to the shape of the concave curvature 1.1 of the capsule 1a. In the first exemplary embodiment shown in FIG. 2, of the solenoid valve 11′ of the invention, a contact region 3.1 occurs between the armature 13a and the capsule 1a in the indentation 9a of the armature 13a and, in the outset position of the armature 13a, contacts the concave curvature 1.1 of the capsule 1a. The contact region 3.1 between the indentation 9a of the armature 13a and the concave curvature 1.1 of the capsule 1.a acts as a stroke stop 1.3 of the armature 13a, and the maximum stroke of the armature 13a can be adjusted via the depth of the concave curvature 1.1 of the capsule 1a. Thus the height of the portion of the valve cartridge 10′ of the solenoid valve 11′ of the invention that is disposed above a fluid block is a length h1 which is shorter than the length h of the valve cartridge 10 of the conventional solenoid valve 11 (h1<h). Under favorable conditions, by means of a skilled adaptation of geometry, the height of the magnet assembly in the direction of the arrow 2.1 can be reduced as well, if the magnetic field lines follow the new armature shape. As a result, the modified armature 13a of the solenoid valve 11′ of the invention has only a very small region that is magnetically unused, or none at all.

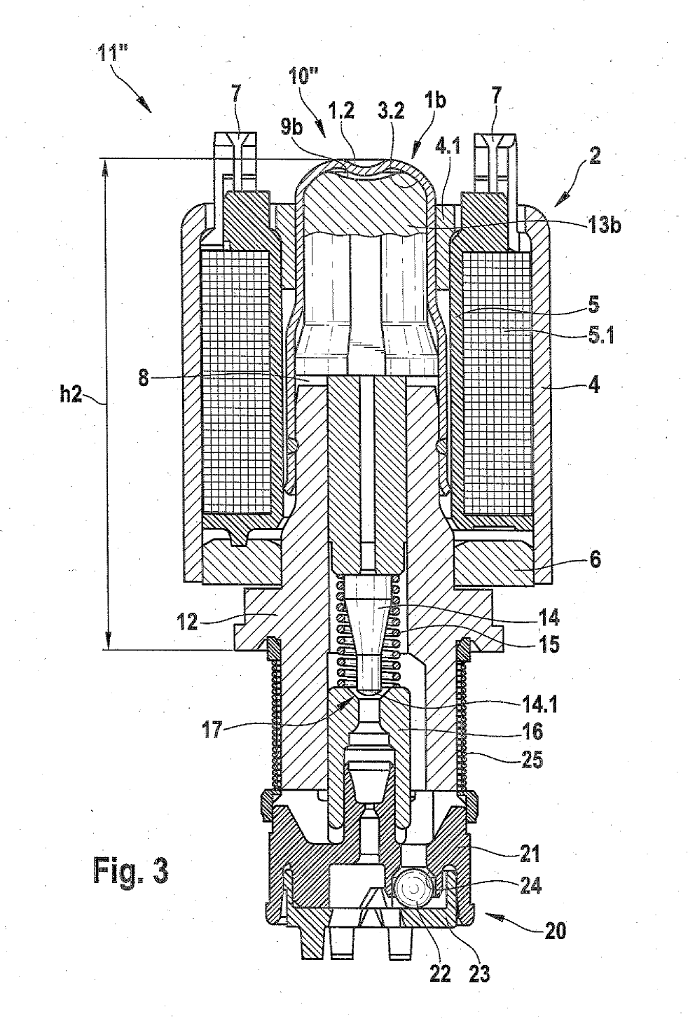

As can be seen from FIG. 3, the second exemplary embodiment of the solenoid valve 11″ of the invention, analogously to the first exemplary embodiment of the solenoid valve 11′ of the invention in FIG. 2 and analogously to the conventional solenoid valve 11 in FIG. 1, includes a magnet assembly 2 for generating a magnetic flux, which assembly includes a housing jacket 4 with an intake 4.1, a winding holder 5, a coil winding 5.1, and a covering disk 6; and a valve cartridge 10″, which includes a capsule 1b, a valve insert 12, an armature 13b with a first closing element 14 embodied as a tappet, and a restoring spring 15. The magnet assembly 2 generates a magnetic force which moves the longitudinally movable armature 13b, with the first closing element 14 embodied as a tappet, toward the valve insert 12 counter to the force of the restoring spring 15. The coil winding 5.1 wound onto the winding holder 5 forms an electrical coil, which is triggerable via electrical terminals 7. The valve insert 12 conducts the magnetic flux, introduced by the magnet assembly 2 via the covering disk 6, axially in the direction of the armature 13b via an air gap 8. The magnetic transition from the armature 13b to the magnet assembly 2 takes place in the upper region of the capsule 1b, via the intake 4.1. As a result of current being supplied to the coil winding 5.1 via the electrical terminals 7 and the magnetic flux generated as a result, the armature 13b is moved toward the valve insert 12, counter to the force of the restoring spring 15. Moreover, the valve insert 12 receives the valve body 16, which includes a primary valve seat 17 into which the first closing element 14, embodied as a tappet, plunges in sealing fashion via a sealing region 14.1 embodied as a sealing dome, in order to achieve the sealing function of the solenoid valve 11″. Moreover, the solenoid valve 11′ of the invention includes a check valve 20.

In a distinction from the conventional solenoid valve 11 of FIG. 1, the capsule 1b of the solenoid valve 11″ of the invention, for reducing the structural height of the valve cartridge 10″, is embodied as shown in FIG. 3 with a concave curvature 1.2, and an upper end of the armature 13b is adapted by means of an indentation 9b to the shape of the concave curvature 1.2 of the capsule 1b. In a distinction from the first exemplary embodiment, shown in FIG. 2, of the solenoid valve 11′ of the invention, the concave curvature 1.2 of the capsule 1b and the indentation 9b of the armature 13b of the second exemplary embodiment of the solenoid valve 11″ of the invention in FIG. 3 are adapted to one another in such a way that a contact region 3.2 between the armature 13.b and the capsule 1b is unchanged from the contact region 3 of the conventional solenoid valve of FIG. 1. This means that the contact region 3.2 between the armature 13.b and the capsule 1b occurs at the edge of the indentation 9b of the armature 13b, which edge, in the outset position of the armature 13b, rests on the edge of the concave curvature 1.2 of the capsule 1b. Thus the height of the portion of the valve cartridge 10″ of the solenoid valve 11″ of the invention that is disposed above a fluid block is a length h2 which is shorter than the length h of the valve cartridge 10 of the conventional solenoid valve 11 and longer than the length h1 of the valve cartridge 10′ of the second exemplary embodiment of the solenoid valve 11′ (h1<h2<h). For instance, the indentation 9b of the armature 13b is embodied as so large that no contact with the concave curvature 1.2 of the capsule 1b ensues here. As a result, the known course of the magnetic field lines, and thus the magnetic behavior, are preserved, at the cost of a lesser reduction in the structural height.

In a feature of the solenoid valves 11′ and 11″ of the invention, the armatures 13a, 13b can each be embodied as a cold-formed part, and the sealing region 14.1 of the first closing element 14 can be reworked by means of a restamping process. An underlay created upon the cold-forming of the respective armature 13a and 13b defines the corresponding indentation 9a and 9b of the armature 13a and 13b in shape and depth.

Because of the novel shaping of the capsule curvature and of the armature in a manner adapted to it, the curved, magnetically unused region of the armature is shortened, so that the total length of the valve cartridge can advantageously be shortened as well.

1-6. (canceled)

7. A solenoid valve, having a magnet assembly and a valve cartridge that includes a capsule and an armature disposed movably inside the capsule, and having a first closing element which cooperates in sealing fashion with a primary valve seat, and a magnetic force generated by the magnet assembly moves the armature with the first closing element, as a result of which the first closing element plunges with a sealing region sealingly into the primary valve seat, wherein for reducing the structural height, the capsule of the valve cartridge is embodied with a concave curvature, and an upper end of the armature is adapted by means of an indentation to the shape of the concave curvature of the capsule.

8. The solenoid valve as defined by claim 7, wherein a contact region occurs between the armature and the capsule in the indentation of the armature, which indentation, in the outset position of the armature, contacts the concave curvature of the capsule.

9. The solenoid valve as defined by claim 8, wherein the contact region between the indentation of the armature and the concave curvature of the capsule acts as a stroke stop of the armature, and the maximum stroke of the armature is adjustable via the depth of the concave curvature.

10. The solenoid valve as defined by claim 7, wherein the concave curvature of the capsule and the indentation of the armature are adapted to one another such that a contact region between the armature and the capsule occurs at an edge of the indentation of the armature and, in an outset position of the armature, occurs at an edge of the concave curvature of the capsule.

11. The solenoid valve as defined by claim 7, wherein the armature is embodied as a cold-formed part, and the sealing region of the first closing element is reworked by means of a restamping process.

12. The solenoid valve as defined by claim 8, wherein the armature is embodied as a cold-formed part, and the sealing region of the first closing element is reworked by means of a restamping process.

13. The solenoid valve as defined by claim 9, wherein the armature is embodied as a cold-formed part, and the sealing region of the first closing element is reworked by means of a restamping process.

14. The solenoid valve as defined by claim 10, wherein the armature is embodied as a cold-formed part, and the sealing region of the first closing element is reworked by means of a restamping process.

15. The solenoid valve as defined by claim 11, wherein an underlay created upon the cold-forming of the armature defines the indentation of the armature in shape and depth.

16. The solenoid valve as defined by claim 12, wherein an underlay created upon the cold-forming of the armature defines the indentation of the armature in shape and depth.

17. The solenoid valve as defined by claim 13, wherein an underlay created upon the cold-forming of the armature defines the indentation of the armature in shape and depth.

18. The solenoid valve as defined by claim 14, wherein an underlay created upon the cold-forming of the armature defines the indentation of the armature in shape and depth.
